(19) United States
(12) Patent Application Publication
(10) Pub. No.: US 2023/0232843 A1
(43) Pub. Date: Jul. 27, 2023

(54) VEGAN COMPOSITION FOR BAKING

(71) Applicant: CARGILL, INCORPORATED, Wayzata, MN (US)

(72) Inventors: Hannah KEENAN, Cheadle (GB); Anneleen Trees Petra Roos VAN WYMEERSCH, Gent (BE); Peter VELDS, Vilvoorde (BE)

(73) Assignee: CARGILL, INCORPORATED, Wayzata, MN (US)

(21) Appl. No.: 17/999,943

(22) PCT Filed: May 28, 2021
(86) PCT No.: PCT/US2021/034751

§ 371 Date: Nov. 28, 2022

(30) Foreign Application Priority Data
May 29, 2020 (EP) 20177516.0

(51) Int. Cl. A21D 2/36; A21D 2/18; A21D 2/26; A21D 10/00; A21D 13/06; A23L 15/00; A23C 11/06

(52) U.S. Cl. CPC A21D 2/36; A21D 2/186; A21D 2/268; A21D 2/264; A21D 2/188; A21D 10/002; A21D 13/06; A23L 15/35; A23C 11/06

(57) ABSTRACT

The invention relates to a vegan composition for use as an egg and/or dairy replacement comprising a starch source, a dietary fiber source and a hydrolyzed vegetable protein. The invention also relates to baked food products, such as cakes, in particular sponge cakes, comprising the composition. The invention also relates to the use of the vegan composition as an egg and/or dairy replacement in baked food products.

### CROSS-REFERENCE TO RELATED APPLICATIONS

This application claims the benefit of European Application No. 20177516.0, filed May 29, 2020, and entitled “VEGAN COMPOSITION FOR BAKING”, which is incorporated by reference herein in its entirety.

### FIELD OF THE INVENTION

The invention relates to a vegan composition for use as an egg and/or dairy replacement, and baked food products comprising the composition.

### BACKGROUND

Eggs and dairy products have traditionally been essential components of many foods, especially baked foods such as cakes, muffins etc. However, the vegan diet, which excludes animal products, is rising in popularity worldwide driven by concerns including health, the environment, and animal welfare. In addition, many people choose not to eat eggs due to their high cholesterol content, egg allergies, or concerns about pathogens such as Salmonella. Accordingly, there is a rising demand for vegan alternatives for foods that normally contain animal products. In particular, there is a demand for a composition that can replace both eggs and/or dairy.

Eggs have many properties that make them particularly useful in baking, for example as a leavening agent, thickener, binder, coagulator, emulsifier, moisturizer, or flavour component. Dairy fats are often used in baking to improve moistness, leavening, or taste. Therefore, the challenge facing the baking industry is to find egg and dairy replacements that can fulfil all the functions mentioned above, but which do not use animal products.

A number of commercial egg replacement powders such as Ener-G® (Ener-G Foods Inc.) are available on the market, but these usually do not fulfil all of the functions of egg, such as binding, moisturizing or flavouring. CAVAMAX® W6 Wacker Chemie AG) is an egg replacement blend containing an alpha-cyclodextrin produced enzymatically from plant starch. The blend is a combination of water, protein and alpha-dextrin which can allegedly be used to replace the egg content of traditional baked products, including cakes.

WO2017/014967 A1 describes an egg substitute composition that is a substantially egg-less dry mixture that includes a starch and/or lipid source and/or protein source, and a mixture of hydrocolloids and a crosslinking agent. The starch, lipid, and protein may be from a plant-based source.

WO02019/081706 A1 describes a protein hydrolysate emulsifier for the preparation of cakes, particularly fat free cakes. The protein hydrolysate may be a plant protein, such as wheat, soy, rice, potato, pea, sunflower or rape seed protein.

However, many products on the market are designed for home baking. There is still an unmet need for an egg and/or dairy replacement composition that is suitable for manufacturing vegan baked goods on an industrial scale. For industrial baking, the ingredients must be cost-effective and be capable of withstanding high levels of physical and mechanical stress, whilst reliably producing a product that has a desirable rise, colour, texture, and taste. Furthermore, there is demand for a single composition that can replace both egg and dairy products, thereby simplifying and streamlining the manufacture of vegan baked goods.

### SUMMARY OF THE INVENTION

The present invention seeks to meet these demands

In one aspect, the invention provides a vegan composition for use in food comprising: a starch, a dietary fibre, and a hydrolyzed vegetable protein, and optionally vital wheat gluten.

The composition may comprise from 10 to 40 wt % starch, preferably from 15 to 30 wt %.

The composition may also comprise from 5 to 30 wt % dietary fibre, preferably from 8 to 20 wt %.

The composition may also comprise from 40 to 80 wt % hydrolyzed vegetable protein, preferably from 50 to 70 wt %.

The composition may also comprise from 1 to 35 wt % vital wheat gluten, preferably from 5 to 25 wt %.

All weight percentage amounts disclosed herein are on a dry weight basis, unless indicated otherwise.

The starch may be a plant-based starch derived from roots, vegetables, legumes, seeds, grains, tubers, fruits, nuts, algae, or pulses, or a combination thereof. Preferably, the starch is tapioca starch.

The dietary fibre may be a plant-based fibre derived from roots, vegetables, legumes, seeds, grains, tubers, fruits, nuts, or combinations thereof. Preferably, the fibre is citrus fibre.

The hydrolyzed vegetable protein may be selected from the group consisting of hydrolyzed wheat protein, hydrolyzed soy protein, hydrolyzed pea protein and hydrolyzed corn protein.

The composition advantageously does not comprise egg, dairy, or any derivatives thereof.

The invention also provides a baked food product (e.g. cake) comprising the composition of the invention.

Additionally, the invention provides for the use of the composition to make a cake or for the composition of the invention as a replacement for eggs and/or dairy.

Furthermore, the invention provides for a kit comprising the composition of the invention (premixed) with one or more ingredients selected from: flour, sugar, fat, oil, chemical leavening agent, such as sodium bicarbonate or baking powder (a dry mixture of sodium bicarbonate and one or more acid salts), a biological leavening agent (e.g. baker's yeast, beer, kefir or sourdough starter), glycerine, salt, and emulsifiers.

### BRIEF DESCRIPTION OF THE FIGURES

FIG. 1 is a photograph depicting a sponge cake prepared using a traditional recipe containing egg.

FIG. 2 is a photograph depicting a cross-section of a vegan sponge cake prepared using the composition of the present invention.

FIG. 3 is a photograph depicting cross sections of various vegan sponge cakes prepared using the composition of the present invention, wherein the cakes have different batter deposit sizes.

FIG. 4 is a photograph depicting cross sections of a plain cupcake, a plain muffin, and a plain loaf cake prepared using the composition of the present invention.

FIG. 5 is a photograph depicting cross sections of a chocolate cupcake, a chocolate muffin, and a chocolate loaf cake prepared using the composition of the present invention.

FIG. 6 is a photograph depicting cross sections of a cupcake, a muffin, a loaf cake and a round sponge cake prepared using the composition of the present invention.

### DESCRIPTION OF THE INVENTION

When used in this specification and claims, the terms “comprises” and “comprising” and variations thereof mean that the specified features, steps or integers are included. The terms are not to be interpreted to exclude the presence of other features, steps or components. However, it is to be understood that the words “comprises” and “comprising” also discloses “consists of” and “consisting of” or “essentially consists of” and “essentially consisting of”.

The present invention provides a vegan composition for use in food. “Vegan” as used herein, denotes that the composition is suitable for consumption by someone following a vegan or plant-based diet who avoids all animal or animal-derived foods such as meat (including fish, shellfish and insects), dairy, eggs and honey. In particular, the composition does not contain any egg or dairy or derivatives thereof (e.g. milk proteins).

The composition comprises a blend of edible ingredients and may be used to fully or partially replace the egg and/or dairy in a traditional recipe. It is particularly useful for replacing the egg and/or dairy in baked food products. Preferred baked food products are those which comprise or consist essentially of a sponge-like or foam-like aerated texture. Non-limiting examples of such baked food products include cakes, particularly sponge cakes, muffins, and some breads which normally contain egg like brioche, challah, banana bread, or pretzels.

Sponge cake is a popular cake variety that is formed by mechanical aeration of cake mixture (i.e. batter) that typically contains flour, eggs, sugar, and sometimes fat, e.g. from butter or milk or oil. Once baked, the batter ingredients form a 3D lattice structure that surrounds and encloses numerous air filled chambers. Non-limiting examples of sponge cakes include shortened or unshortened sponge cakes, angel cake, pound cake, Victoria sponge, loaf cake, fruit cake, muffins, cupcakes, Swiss roll, Bakewell tart, frangipane tart, chiffon cake, soufflé, or flourless cakes etc.

Eggs have several important functions in a sponge cake mixture. Once cooked, the proteins in the egg effectively form a scaffold that gives structure to the sponge and helps the cake to rise effectively. Eggs also bind the cake ingredients together and add moisture to the cake. Removing eggs tends to lead to a dry, crumbly sponge that is liable to collapse inwards after baking.

The use of eggs and dairy makes such traditional sponge cakes unsuitable for vegans, who abstain from consuming animal products.

The composition of the invention comprises or (essentially) consists of a starch, a dietary fibre, and a hydrolyzed vegetable protein. Preferably, the starch, dietary fibre, and/or hydrolyzed vegetable protein are derived from a plant source or a non-animal source. For instance, the starch, dietary fibre and/or hydrolyzed protein may be derived from roots, vegetables, legumes, seeds, grains, tubers, fruits, nuts, algae, or pulses.

Non-limiting examples of suitable starches include starch derived from cassava, maize, potato, wheat, rice, sorghum, beans, peas, soy, or modified starch. Without being bound by theory, it is thought that the starch adds structure to the foam texture, preventing collapse during and after baking and trapping air bubbles. Advantageously, the starch is tapioca starch which was found to be a particularly effective thickener and to provide a particularly pleasant creamy texture to a baked good, such as a sponge cake. Tapioca starches are commercially available, for example Cream Gel™ sold by Cargill Inc.

Dietary fibre is the portion of plant-derived food that cannot be completely broken down by human digestive enzymes. Such fibres were found to be useful in the composition due to their ability to absorb liquid, thereby imparting moisture to a baked good, such as a sponge cake. Any fibre which has this property may be used in the composition regardless of whether they are soluble or insoluble. Non-limiting examples of suitable fibres include those derived from citrus fruits, oats, wheat, barley, bamboo, sugar beet, sugar cane, tomato, coconut, pea, potato, cellulose, hemi-cellulose, chitosan, pectins, gums, mucilages, lignins, or psyllium, as well as starch derived bulking agents which comprise dietary fibres, such as dextrins, polydextrose, and resistant starches. Advantageously, the fibre is citrus fibre.

Citrus fibres are microfibrils of cellulose extracted from citrus fruits. Common varieties of citrus fruits include oranges, sweet oranges, clementines, kumquats, tangerines, tangelos, satsumas, mandarins, grapefruits, citrons, pomelos, lemons, rough lemons, limes and leech limes. Citrus fibres are typically obtained from citrus peel, citrus pulp, citrus rag or combinations thereof by drying and extracting juice, oils, and other non-fibrous compounds from the fruit. One example of commercially available citrus fibre is Herbacel® AQ® Plus (Herbafood Ingredients GmbH). Citrus fibres have a high water-binding capacity making them especially useful for thickening and emulsifying applications.

Hydrolyzed proteins are derived from the hydrolysis of a protein into its component amino acids and peptides. Various methods are known in the art for achieving this, including acid hydrolysis, and enzyme hydrolysis. The term “hydrolyzed vegetable protein” as used herein refers to hydrolyzed proteins from a plant source. Non-limiting examples of such plant sources are wheat, pea, soy, and corn (i.e. maize). Advantageously, the hydrolyzed protein has a degree of hydrolysis of about 0.1 to 1.5%, preferably 0.5 to 10%, more preferably 1 to 8%, as measured according to the OPA method. Advantageously, the hydrolyzed vegetable protein is hydrolyzed wheat protein. One example of a commercially available hydrolysed wheat protein is ProwLiz® 21110 sold by Cargill Inc. Other plant sources may be preferred if it is necessary for the baked food product to be gluten-free. Alternatively, the hydrolyzed vegetable protein is hydrolyzed pea protein, such as Radipure™ E8001G sold by Cargill Inc.

The composition may further comprise vital wheat gluten. Vital wheat gluten is the water-insoluble protein fraction isolated from wheat flour, whereby the high viscoelastic properties of the gluten are maintained. Gluvital™ 21020 sold by Cargill Inc. can be used.

The starch, dietary fibre, and hydrolyzed vegetable protein, may be mixed or blended Bing any suitable means to make the composition.

The composition preferably comprises from 10-40 wt % starch, and from 5-30 wt % dietary fibre, and from 40-80 wt % hydrolyzed vegetable protein and optionally from 1 to 35 wt % vital wheat gluten. The composition more preferably comprises from 15-30 wt % starch, and from 8-20 wt % dietary fibre, and from 50-70 wt % hydrolyzed vegetable protein and optionally from 5 to 25 wt % vital wheat gluten.

The composition may also (essentially) consist of from 10-40 wt % starch, and from 5-30 wt % dietary fibre, and from 40-80 wt % hydrolyzed vegetable protein and optionally from 1 to 35 wt % vital wheat gluten. The composition may also preferably (essentially) consists of from 15-30 wt % starch, and from 8-20 wt % dietary fibre, and from 50-70 wt % hydrolyzed vegetable protein and optionally from 5 to 25 wt % vital wheat gluten.

Furthermore, the vegan composition of the invention is a dry blend e.g. a dry blend of powders. The vegan composition of the invention is not an emulsion.

Furthermore the vegan composition preferably does not comprise a hydrocolloid. Furthermore the vegan composition preferably does not comprise a lipid or fat source. By a lipid or fat source it is meant herein a food ingredient that contains more than 10 wt % of fat.

The vegan composition of the invention generally comprises less than 10 wt %, of water, preferably less than 6 wt %, more preferably less than 5 wt %, most preferably less than 4 wt %.

The vegan composition of the invention generally comprises less than 10 wt % of fat, preferably less than 6 wt %, more preferably less than 5 wt %, most preferably less than 4 wt %. Any fat present in the vegan composition is inherently present in the starch, a dietary fibre, hydrolyzed vegetable protein and optional vital wheat gluten.

Baked food products (as defined above) which comprise the aforementioned composition also form part of the invention. In addition to the composition of the invention, the baked food product may also comprise additional ingredients such as sugar (preferably caster sugar, granulated sugar, icing sugar, or high intensity sweeteners and bulking agents), wheat flour (preferably heat-treated), gluten-free flour, fat, oil, glycerine, emulsifiers, chemical or biological leavening agents, texturizing agents, flavourings such as vanilla or vanillin or ethylvanillin, cocoa solids/powder, chocolate/cocoa liquor (also known as cocoa mass), and inclusions such as fruits, nuts, chocolate chips etc. The fat or oil is preferably plant-based in order to prepare a vegan baked food product. Suitable fats include coconut fat, cocoa butter and hydrogenated oils. Suitable oils include (high oleic) sunflower oil, canola oil, olive oil, linseed oil and the like. The baked good may also be filled, frosted, glazed, iced, topped, or decorated with other substances.

The baked food product (e.g. cake) may further comprise flour, in particular wheat flour. Preferably, the flour has a protein content of at least 10 wt % and/or a fiber content of at least 2 wt % and/or a carbohydrate content of less than 70 wt %. The inventors have observed that the lower the protein content of the flour, the higher the dosage of the vegan composition that will be required in order to satisfactorily replace egg and dairy in the recipe of the baked food product (e.g. cake).

The use of the composition to make a baked food product (e.g. cake), and/or as a replacement or substitute for eggs and/or dairy is also part of the invention. In this context the term “replace” or “replacement” should not be interpreted to mean that egg and/or dairy must initially be present in the batter and is subsequently removed in exchange for the composition. Rather, the composition may be used instead of some or all of the egg and/or dairy in a traditional, i.e. non-vegan, recipe for the baked food product, or the recipe may be originally be designed to use the composition.

The composition may also be part of a kit, for example a vegan cake mix kit. Cake mix kits are popular amongst home bakers as they offer a quick, easy and inexpensive way to bake. Typically, cake mix kits comprise a pre-mixed blend of all the dry ingredients to make a cake. All the user then has to do is add a liquid, e.g. water and/or oil and/or non-dairy milk alternative, before stirring and baking according to packet instructions. The present kit comprises the composition of the invention, as well as one or more typical cake ingredients such as flour, sugar, fat, oil, a chemical leavening agent, salt, acids (e.g. citric acid), flavourings (as described above), texturizing agents, preservatives, and emulsifiers. The leavening agent may be baking soda (also known as bicarbonate of soda or sodium bicarbonate) and/or baking powder, which commonly contains sodium bicarbonate, one or more acid salts and optionally a starch buffer.

### CLAUSES OF THE INVENTION

The invention also covers the following:

CLAUSE 1. A vegan composition for use in food, in particular in baked food products, comprising:
a starch; and
a dietary fibre; and
a hydrolyzed vegetable protein.

CLAUSE 2. The composition of claim 1 further comprising vital wheat gluten.

CLAUSE 3. The composition of clause 1 or 2 comprising from 10 to 40 wt % starch, preferably from 15 to 30 wt %.

CLAUSE 4. The composition of any one of the preceding clauses comprising from 5 to 30 wt % dietary fibre, preferably from 8 to 20 wt %.

CLAUSE 5. The composition of any one of the preceding clauses comprising from 40 to 80 wt % hydrolyzed vegetable protein, preferably from 50 to 70 wt %.

CLAUSE 6: The composition of any one of the preceding clauses comprising from 1 to 35 wt % vital wheat gluten, preferably from 5 to 25 wt %, more preferably 10 to 15 wt %.

CLAUSE 7. The composition of any one of the preceding clauses, wherein the starch is a plant-based starch derived from roots, vegetables, legumes, seeds, grains, tubers, fruits, nuts, algae, or pulses, or a combination thereof.

CLAUSE 8. The composition of clause 7, wherein the starch is tapioca starch.

CLAUSE 9. The composition of any one of the preceding clauses, wherein the dietary fibre is a plant-based fibre derived from roots, vegetables, legumes, seeds, grains, tubers, fruits, nuts, or combinations thereof.

CLAUSE 10. The composition of clause 9, wherein the fibre is citrus fibre.

CLAUSE 11. The composition of any one of the preceding clauses, wherein the hydrolyzed vegetable protein is selected from the group consisting of hydrolyzed wheat protein, hydrolyzed pea protein, hydrolyzed soy protein, and hydrolyzed corn protein.

CLAUSE 12. The composition of clause 11, wherein the hydrolyzed vegetable protein is hydrolyzed wheat protein.

CLAUSE 13. The composition of any one of the preceding clauses, wherein the composition does not comprise egg, dairy, or any derivatives thereof.

CLAUSE 14. The composition of any one of the preceding clauses, wherein the composition is a dry blend e.g. a dry blend of powders.

CLAUSE 15. The composition of any one of the preceding clauses, wherein the composition is not an emulsion.

CLAUSE 16. The composition of any one of the preceding clauses, wherein the composition has a water content of less than 6 wt %, preferably less than 5 wt %, more preferably less than 4 wt %.

CLAUSE 17. The composition of any one of the preceding clauses, wherein the composition has a fat content of less than 6 wt %, preferably less than 5 wt %, more preferably less than 4 wt %.

CLAUSE 18. A baked food product comprising the composition of any one of clauses 1 to 17.

CLAUSE 19. A baked food product according to clause 18, wherein the baked food product is vegan.

CLAUSE 20. A baked food product according to clause 18 or 19, wherein the baked food product is a cake, preferably further comprising flour, sugar, and fat. The cake may optionally also comprise leavening agent, salt, glycerine, acids, emulsifiers, flavourings, texturizing agents, preservatives, and inclusions.

CLAUSE 21. A baked food product according to clause 20, wherein the flour has a protein content of at least 10 wt % and/or a fiber content of at least 2 wt % and/or a carbohydrate content of less than 70 wt %.

CLAUSE 22. Use of the composition of any one of clauses 1 to 17 to make a baked food product, such as a cake (e.g. a sponge cake, a muffin, a brioche or the like).

CLAUSE 23. Use of the composition of any one of clauses 1 to 17 as a full or partial replacement for eggs and/or dairy.

CLAUSE 24. A kit comprising the composition of any one of clauses 1 to 17 and one or more ingredients selected from: flour, sugar, fat, oil, a leavening agent, salt, and emulsifiers. The kit is for baking cakes in domestic ovens.

### EXAMPLES

### Example 1 (Comparative Example)

### Egg-Based Sponge Cake

Traditional sponge cakes were prepared using egg. The recipe is provided in table 1.

TABLE 1
Recipe for egg-based sponge cake

| Ingredients | % | Kg |
|---|---|---|
| Baking powder | 0.8 | 8 |
| Heat-treated flour (Meneba | 29.5 | 295 |
| Flamingo specialist flour) | | |
| Caster sugar | 24 | 240 |
| Sorbitol C*Pharmidex NC 16205 | 5 | 50 |
| High Oleic Sunflower oil | 13 | 130 |
| Water | 11 | 110 |
| Whole liquid egg | 15 | 150 |
| Salt | 0.2 | 2 |
| Bisquita gel (Dawn Food products, Inc.) | 1.5 | 15 |
| TOTAL | 100 | 1000 |

The cakes were prepared according to the following method:

| | |
|---|---|
| Step 1 | Weigh out liquid ingredients. |
| Step 2 | Weigh out dry ingredients, mix and sieve. |
| | Add dry ingredients to the liquid ingredients and blend. |
| Step 3 | Mix for 2 mins at low speed. |
| Step 4 | Scrape down. |
| Step 5 | Mix for a further 3 mins at higher speed. |
| Step 6 | Fill 8″ cake tins. |
| Step 7 | Bake for 60 mins in a preheated oven at 160° C.-180° C. |

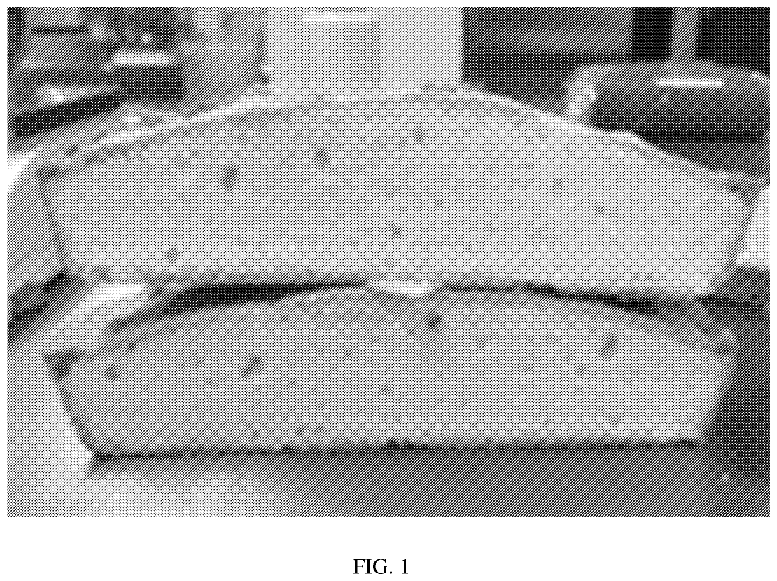

A resulting cake is shown in FIG. 1.

### Example 2

### Vegan Sponge Cake

Vegan sponge cakes were prepared using the egg replacement composition of the present invention. The egg replacement composition consisted of about 20 wt % tapioca starch (Tapioca C* Cream Gel 70001), of about 20 wt % citrus fibre (Herbacel® AQ® Plus) and about 60 wt % hydrolyzed wheat protein (Prowliz® 21110) on a dry weight basis. The composition is a dry blend of these ingredients with a total of less than 4 wt % moisture content and less than 4 wt % fat content. The recipe is provided in table 2.

TABLE 2
Recipe for vegan sponge cake

| Ingredient | % | Kg |
|---|---|---|
| Egg replacement composition | 6.25 | 62.5 |
| Emulsifier - Emulpals ® 110 (Palsgaard ®) | 0.00 | 0.00 |
| Baking powder | 0.80 | 8.00 |
| Heat-treated flour (Meneba Flamingo specialist | 25.00 | 250.00 |
| flour) | | |
| Caster sugar | 22.00 | 220.00 |
| 99.5% Glycerine | 4.00 | 40.00 |
| Bisquita gel (Dawn Food products, Inc.) | 0.70 | 7.00 |
| High Oleic sunflower oil | 14.00 | 140.00 |
| Water | 27.25 | 272.50 |
| TOTAL | 100.00 | 1000 |

The sponge cakes were prepared using the following method.

| | |
|---|---|
| Step 1 | Add all dry ingredients into a mixing bowl. |
| Step 2 | Stream liquids into the dry ingredients and mix |
| | for 2 min at slow speed. |
| Step 3 | Scrape down. |
| Step 4 | Mix at higher speed for a further 2 mins. |
| Step 5 | Fill 8″ sponge cake tins and put in the oven at 170-190° C. |
| Step 6 | Bake for 45 mins. |

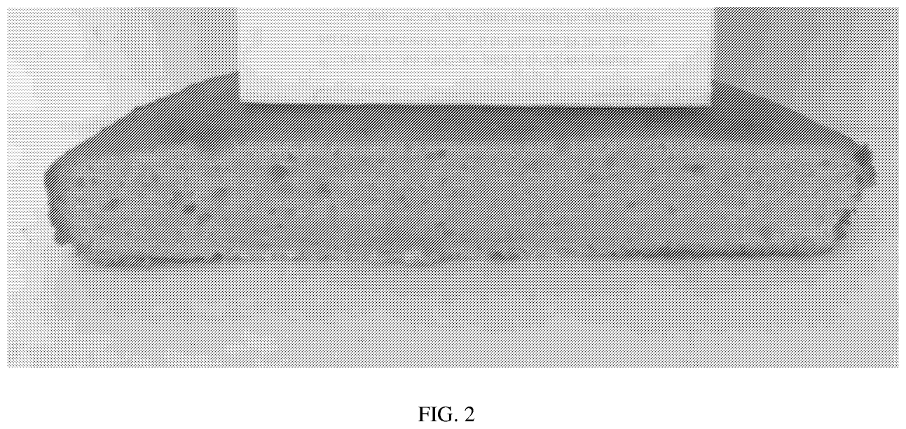

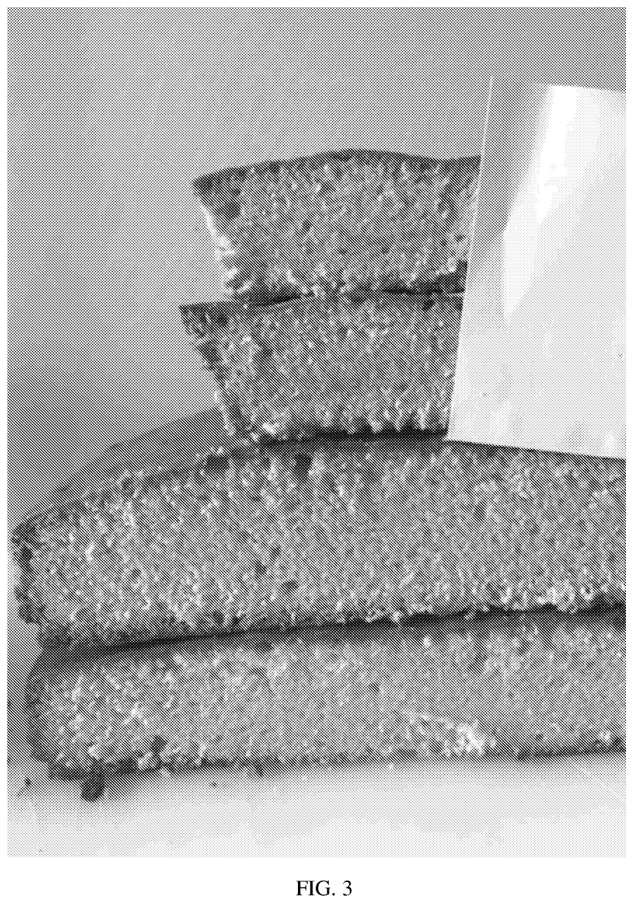

Resulting vegan sponge cakes are shown in FIGS. 2 and 3. As can be seen from the figures, the cakes had excellent rise and colour, and a homogeneous texture and uniform crumb. The vegan sponge cakes prepared using the composition of the invention compared favourably to the sponge cake shown in FIG. 1.

### Example 3

### Vegan Cupcake, Muffin, and Loaf Cake

Plain and chocolate varieties of cupcakes, muffins, and loaf cakes were prepared using the egg replacement composition of the invention. The egg replacement composition was the same as used in Example 2. The recipes for the cakes are provided in table 3.

TABLE 3
Recipe for vegan cupcake, muffin, and loaf cake

| | Plain | | Chocolate | |
|---|---|---|---|---|
| | recipe | | recipe | |
| Ingredient | % | Kg | % | Kg |
| Heat-treated flour (Meneba | 26.30 | 263.00 | 22.30 | 223.00 |
| Flamingo specialist flour) | | | | |
| Caster sugar | 27.00 | 270.00 | 27.00 | 270.00 |
| Baking powder | 0.80 | 8.00 | 0.80 | 8.00 |
| Cocoa powder | 0.00 | 0.00 | 4.00 | 40.00 |
| Egg replacement composition | 2.50 | 25.00 | 2.50 | 25.00 |
| Emulsifier (Dawn Food | 0.40 | 4.00 | 0.40 | 4.00 |
| products, Inc.) | | | | |
| Glycerine | 4.00 | 40.00 | 4.00 | 40.00 |
| Oil | 16.00 | 160.00 | 16.00 | 160.00 |
| Water | 23.00 | 230.00 | 23.00 | 230.00 |
| TOTAL | 100 | 1000 | 100 | 1000 |

The cakes were prepared according to the following method:

| | |
|---|---|
| Step 1 | Add all dry ingredients into a mixing bowl. |
| Step 2 | Stream liquids into the dry ingredients and mix |
| | on slow speed for 2 mins. |
| Step 3 | Scrape down. |
| Step 4 | Mix at higher speed for a further 3 mins. |
| Step 5 | Put 70 g into a standard muffin tin and bake at 80° C. for |
| | 28 mins. |
| Step 6 | Put 35 g into a cupcake tin and bake at 160° C. for 22 mins. |
| Step 7 | Put 350 g into a loaf tin or foil and bake at 180° C. for 45 mins. |

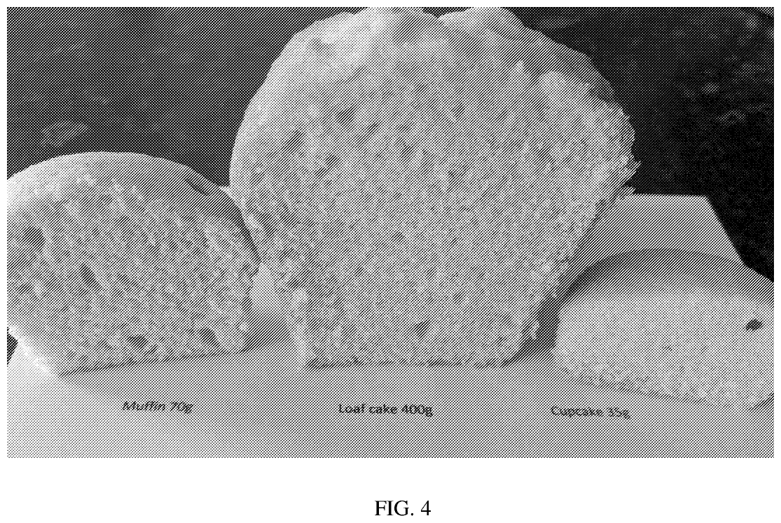

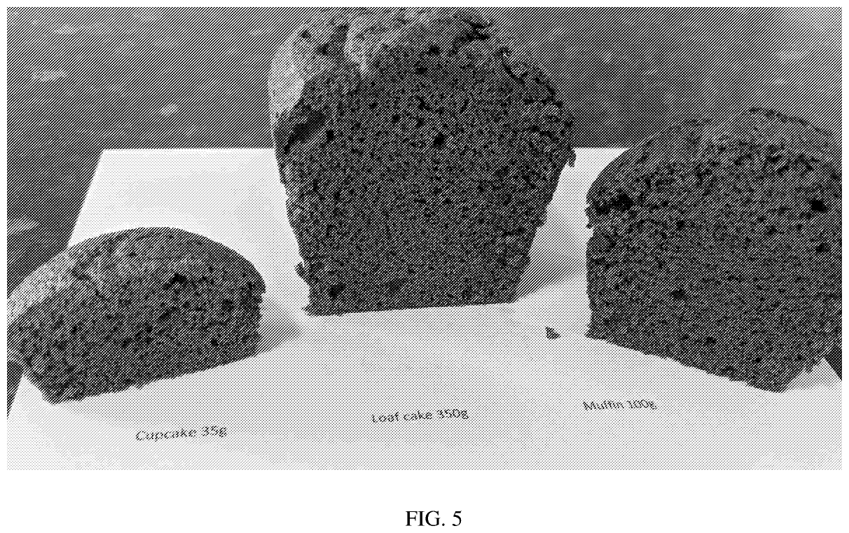

Resulting cakes are show in FIGS. 4 and 5. As can be seen from the figures, the cakes had excellent rise and colour, and a homogeneous texture and uniform crumb.

### Example 4

### Vegan Cupcake, Muffin, and Loaf Cake Sponge Recipe

Sponge cupcakes, muffins, and loaf cakes were prepared using the egg replacement composition of the invention. The egg replacement composition was the same as the composition used in Example 2, but with the addition of about 10 wt % vital wheat gluten (Gluvital™ 21020) on a dry weight basis, whilst maintaining the same ratios between the tapioca starch, citrus fibre and hydrolyzed wheat protein. The composition is a dry blend of these 4 ingredients with a total of less than 4 wt % moisture content and less than 4 wt % fat content.

The recipes for the cakes are provided in table 4.

TABLE 4
Recipe for vegan cupcake, muffin, and loaf cake

| | Plain | |
|---|---|---|
| | recipe | |
| Ingredient | % | Kg |
| Heat-treated flour (Meneba | 29 | 290 |
| Flamingo specialist flour) | | |
| Caster sugar | 27 | 270 |
| Baking powder | 0.5 | 5 |
| Egg replacement composition | 3.5 | 35 |
| Citric acid | 0.05 | 0.5 |
| Emulsifier (Dawn Food products, Inc.) | 0.7 | 7 |
| Glycerine | 4 | 40 |
| Oil | 10 | 100 |
| Water | 25.3 | 252.5 |
| TOTAL | 100 | 1000 |

The cakes were prepared according to the following method:

| | |
|---|---|
| Step 1 | Add all dry ingredients into a mixing bowl. |
| Step 2 | Stream liquids into the dry ingredients and mix on slow |
| | speed for 2 mins. |
| Step 3 | Scrape down. |
| Step 4 | Mix on medium speed for a further 4 mins. |
| Step 5 | Put 650 g into an 8 inch sponge tin and bake at 170° C. |
| | for 60 mins. |
| Step 6 | Put 100 g into tulip muffin cases and bake at 180° C. |
| | for 32 mins. |
| Step 7 | Put 35 g into a cupcake paper cases and bake at 170° C. |
| | for 22 mins. |
| Step 8 | Put 350 g into a loaf tin and bake at 180° C. for 45 mins. |

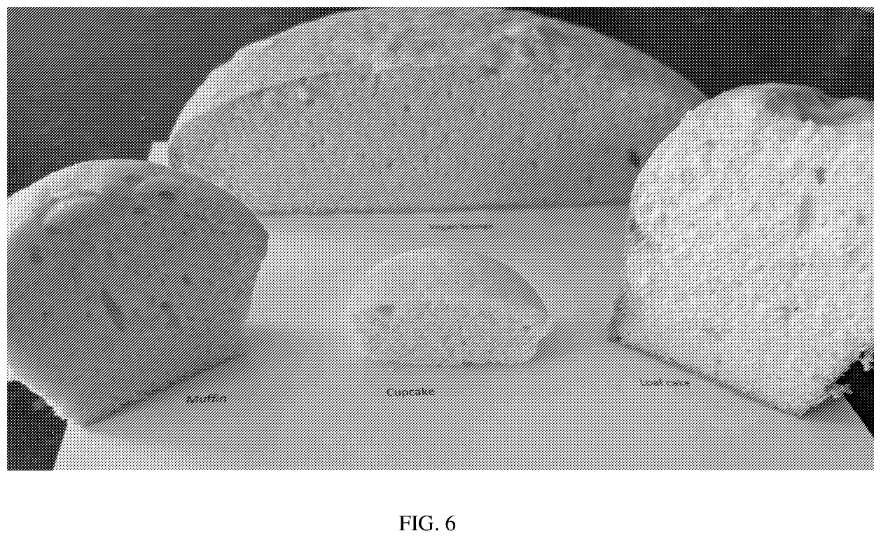

FIG. 6 shows the sponge cake, muffin cake, cupcake and loaf cake all had excellent rise and colour, and a homogeneous texture and uniform crumb similar to the sponge recipe of Example 2. However, compared to example 2, the total amount of the egg replacement composition in the baked food product could be further reduced from 6.25 to 3.5 wt % thanks to the presence of vital wheat gluten in the composition and the adjustment of flour and sugar content. Thus the composition is a suitable egg and dairy replacement for use in baked food products, in particular cakes.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A vegan composition for use in food comprising:
a starch; and
a dietary fibre; and
a hydrolyzed vegetable protein.

2. The composition of claim 1 further comprising vital wheat gluten.

3. The composition of claim 1 comprising from 10 to 40 wt % starch, preferably from 15 to 30 wt %.

4. The composition of claim 1, comprising from 5 to 30 wt % dietary fibre, preferably from 8 to 20 wt %.

5. The composition of claim 1, comprising from 40 to 80 wt % hydrolyzed vegetable protein, preferably from 50 to 70 wt %.

6. The composition of claim 1, comprising from 1 to 35 wt % vital wheat gluten, preferably from 5 to 25 wt %.

7. The composition of claim 1, wherein the starch is a plant-based starch derived from roots, vegetables, legumes, seeds, grains, tubers, fruits, nuts, algae, or pulses, or a combination thereof.

8. The composition of claim 7, wherein the starch is tapioca starch.

9. The composition of claim 1, wherein the dietary fibre is a plant-based fibre derived from roots, vegetables, legumes, seeds, grains, tubers, fruits, nuts, or combinations thereof.

10. The composition of claim 9, wherein the fibre is citrus fibre.

11. The composition of claim 1, wherein the hydrolyzed vegetable protein is selected from the group consisting of hydrolyzed wheat protein, hydrolyzed pea protein, hydrolyzed soy protein, and hydrolyzed corn protein.

12. The composition of claim 1, wherein the composition is a dry blend.

13. The composition of claim 1, wherein the composition has a water content of less than 10 wt %, preferably less than 6 wt %, more preferably less than 5 wt %, most preferably less than 4 wt %.

14. A baked food product comprising the composition of claim 1.

15. (canceled)

16. (canceled)

17. A kit comprising the composition of claim 1 and one or more ingredients selected from: flour, sugar, fat, oil, a leavening agent, salt, and emulsifiers.
